(19) United States
(12) Patent Application Publication
(10) Pub. No.: US 2023/0331898 A1
(43) Pub. Date: Oct. 19, 2023

(54) HEAT-CURABLE POLYURETHANE COMPOSITIONS

(71) Applicant: SIKA TECHNOLOGY AG, Baar (CH)

(72) Inventors: Michael SCHLUMPF, Stallikon (CH); Sven REIMANN, Zürich (CH)

(73) Assignee: SIKA TECHNOLOGY AG, Baar (CH)

(21) Appl. No.: 18/026,628

(22) PCT Filed: Nov. 30, 2021
(86) PCT No.: PCT/EP2021/083607

§ 371 Date: Mar. 16, 2023

(30) Foreign Application Priority Data
Dec. 4, 2020 (EP) 20212027.5

(51) Int. Cl. C08G 18/48; C08G 18/10; C08G 18/32; C08G 18/38; C08G 18/30; C08L 75/08; C08G 18/24

(52) U.S. Cl. CPC C08G 18/3834; C08G 18/10; C08G 18/246; C08G 18/307; C08G 18/3262; C08G 18/4841; C08L 75/08; C08G 2170/00; C08G 2190/00

(57) ABSTRACT

A nitrogen compound having a melting point of at least 65° C. is used as a curing agent for heat curing in a heat-curable single-component polyurethane composition, which includes a prepolymer with isocyanate end groups made of at least one polyisocyanate and at least one polyol, wherein the solid nitrogen compound is selected from a polyamine, a hydrazide or mixtures thereof.

### TECHNICAL FIELD

The invention relates to the use of a nitrogen compound as curing agent for thermal curing in a heat-curable polyurethane composition. The invention further relates to a heat-curable polyurethane composition and to a method of curing such a composition.

### STATE OF THE ART

Polyurethane compositions have long been known and are used in many sectors, for example as adhesives, sealants or coatings in the building and manufacturing industries. A distinction is made between one-component (1 K) and two-component (2 K) polyurethane (PUR) compositions. In the case of the 1 K polyurethane compositions, where all constituents are present in one component, a further distinction can be made between moisture-curing compositions that cure under the influence of air humidity, and heat-curing compositions where curing is induced by heating.

WO 2009/080738 A1 (Sika Technology AG) describes, for example, a moisture-curing polyurethane composition including a polyisocyanate and an aldehyde- or ketone-blocked amine as moisture-activatable crosslinker. These compositions cure with moisture at room temperature or slightly elevated temperature, especially below 40° C., forming aldehydes and/or ketones. In order to distinctly reduce unwanted outgassing of the aldehydes and ketones in the cured state, the composition contains hydrazides that react with the aldehydes and/or ketones at temperatures above 80° C. to give low volatile components.

Heat-curing polyurethane compositions are used primarily as adhesives and sealants in industrial manufacture. They are used in particular as sealants in vehicle construction, where the heat-curing polyurethane compositions are cured, for example, after the painting of the components, together with the curing of the paint, in appropriate curing ovens, typically at temperatures of > 110° C.

In heat-curing polyurethane compositions, thermally labile curing agents or heat-activatable curing agents are used, which initiate the process of curing the composition at a defined temperature.

EP 0 255 572 A1 (Sika AG) describes, for example, a one-component adhesive and/or sealing compound containing a prepolymer based on polyurethane and a heat-activatable curing agent, wherein the stoichiometric ratio between prepolymer and curing agent is chosen such that only partial crosslinking is possible in the case of heating to temperatures of 60 to 180° C. and a product having highly viscous to plastic properties is obtained. Curing agents mentioned are dicyandiamides or the sodium chloride complex salt of 4,4′-diaminodiphenylmethane.

In addition, there are polyurethane compositions that are curable both by heat and by moisture. If the curing process with moisture and with heat proceeds by the same mechanisms and the mechanical properties of the cured product are essentially or at least largely independent of the manner of curing, the system is referred to as a dual-cure system. If the curing routes proceed via different mechanisms, different mechanical properties are typically obtained, i.e. the system is not a dual-cure system in the actual sense.

WO 88/06165 (Teroson GmbH) describes, for example, heat- and moisture-curing one-component polyurethane sealants and adhesives that contain an isocyanate-containing prepolymer formed from aromatic diisocyanates and polyols, a catalyst for moisture curing and a blocked, heat-activatable crosslinking agent such as a methylenedianiline/sodium chloride complex or microencapsulated polyamine- or polyhydroxy-functional compounds. The encapsulation consists of a polymeric material and has a softening point of more than 60° C. Polyamine- or polyhydroxy-functional compounds used are low molecular weight difunctional amines or alcohols that are liquid at temperatures above 60° C.

WO 2015/040097 A1 (Sika Technology AG) relates to the use of a complex of 4,4′-methylenedianiline and a sodium salt as curing agent in a dual-cure polyurethane composition, wherein the complex is effective as curing agent for moisture curing and for thermal curing alike.

In the case of currently known heat-curable polyurethane compositions, however, there is usually the problem that incomplete reaction of the curing agent during curing, for example at curing temperatures that are too low, can have the effect that the curing agent exudes as an oily liquid from the cured product, which is of course undesirable. Moreover, this makes it difficult to formulate polyurethane compositions having dual-cure properties. Other heat-curable polyurethane compositions are costly and inconvenient in terms of production (for example when microencapsulation is required), do not have sufficient storage stability or are not activatable and curable in a controlled manner to the desired degree.

There is therefore still a need for improved solutions that have the disadvantages mentioned to a lesser degree, if at all.

### SUMMARY OF THE INVENTION

It is therefore an object of the invention to provide a polyurethane composition that overcomes the aforementioned disadvantages and is particularly suitable as a one-component adhesive and/or sealant composition. The composition is preferably to be storage-stable for as long as possible even at relatively high ambient temperatures. A further aim is that the composition has maximum stability to separation or segregation of components, especially also in the case of an only partial or incomplete thermal curing reaction as can occur, for example, at curing temperatures that are too low. More preferably, the composition may additionally be cured both by heat and by air humidity. This is especially the case in that the mechanical properties of the cured product are essentially or at least largely independent of the manner of curing, such that the composition can be used as a dual-cure system.

It has been found that, surprisingly, the object can be achieved by the use as claimed in claim 1. The core of the invention is accordingly the use of a nitrogen compound having a melting point of at least 65° C. as curing agent for thermal curing in a heat-curable one-component polyurethane composition comprising a prepolymer having isocyanate end groups, formed from at least one polyisocyanate and at least one polyol, wherein the solid nitrogen compound is selected from a polyamine, a hydrazide or mixtures thereof.

It has been found that the nitrogen compounds of the invention can be used specifically as curing agents in typical 1 K polyurethane compositions. It is thus possible to provide storage-stable 1 K heat-curable polyurethane compositions that are suitable as adhesives and/or sealants and can be cured in a controlled manner over and above a defined temperature, for example in the range of 80-120° C. or higher.

Additionally obtainable are compositions that are stable to separation of the components even in the case of incomplete thermal curing reaction as occur, for example, at curing temperatures that are too low. In particular, it is possible to effectively avoid the problem of exudation of oily liquids from the cured product.

Without being tied to the theory, it is assumed that the reason for this is that the nitrogen compounds used as curing agents, in addition to the specifically selected chemical structure in the form of polyamines and/or hydrazides, have a relatively high melting point, which ensures that any unconverted curing agent remains in the cured product in the unreacted state. Even if a certain proportion of the prepolymer in a heat-curing composition does cure via humidity before the actual thermal curing, such that there is a shift in the ratio of available polymers to the curing agent, the excess of curing agent is not a problem with regard to segregation.

Moreover, it has been found that the inventive use makes it possible to produce polyurethane compositions having dual-cure properties. In other words, polyurethane compositions obtainable thus include those that can be cured both by heat and by air humidity, where the mechanical properties of the cured product are essentially or at least largely independent of the manner of curing. This is particularly true when the nitrogen compound used as curing agent comprises or consists of hydrazides.

The uses of the polyurethane compositions obtainable by the use of the invention include those as sealants and adhesives in industrial manufacture, in particular as sealants in vehicle manufacture.

A further advantage of the present invention is that it is possible to dispense with problematic substances, for example 4,4′-methylenedianiline, which is classified as a substance of very high concern (SVHC) under REACH legislation, and to provide unexpectedly advantageous alternatives.

In addition, it is possible to mix the nitrogen compound directly with the prepolymer in solid form, especially in powder form, without having to specially treat the curing agent, for example via encapsulation, or other complex measures having to be taken.

Further aspects of the invention are the subject of further independent claims. Particularly preferred embodiments of the invention are subject matter of the dependent claims.

### MODE OF EXECUTION OF THE INVENTION

A first aspect of the present invention relates to the use of a nitrogen compound having a melting point of at least 65° C. as curing agent for thermal curing in a heat-curable one-component polyurethane composition comprising a prepolymer having isocyanate end groups, formed from at least one polyisocyanate and at least one polyol, wherein the nitrogen compound is selected from a polyamine, a hydrazide or mixtures thereof.

Compound names beginning with “poly” refer to substances containing two or more of the functional groups that occur in their name per molecule. The compounds may be monomeric, oligomeric or polymeric compounds. A polyol is, for example, a compound having two or more hydroxyl groups. A polyisocyanate is a compound having two or more isocyanate groups.

Isocyanate-reactive compounds are compounds that have at least one isocyanate-reactive group that can react with isocyanate groups to form a chemical bond.

A one-component polyurethane composition is a composition where the constituents are mixed in one component. In general, a one-component composition is storage-stable at room temperature (e.g. 23° C.) and, in the case of a moisture-curable system, at least over a certain period of time (for example at least one month) with exclusion of moisture, without any significant change in terms of its composition or its properties.

The term “storage-stable” relates to the property of a substance or a composition that it can be stored at room temperature in a suitable container over several weeks up to 6 months or more, without any change in its application or use properties to a degree of relevance for the use thereof as a result of the storage.

Average molecular weight means number-average molecular weight (Mn) here, which can be determined by gel permeation chromatography (GPC) against polystyrene standard.

All the figures that follow, especially relating to the polyurethane composition, to the method and to the uses, are of course equally applicable to the use of the invention, the method of the invention, the products obtainable therefrom and the adhesive and/or sealant compositions of the invention, even if there is no separate reference thereto.

Thermal curing is understood to mean curing at an elevated temperature of, for example, at least 80° C., in particular at least 100° C., especially more than 120° C. Thermal curing is especially conducted at a temperature above the melting point of the nitrogen compound. Thermal curing is especially independent of moisture (such as air humidity) or other external influences, except for the heat supplied.

In the case of thermal curing, the polyurethane composition is simultaneously cured throughout after application. By contrast, in the case of moisture curing, there is diffusion-controlled curing of the polyurethane composition after application from the outside inward. Moisture curing is understood to mean curing under moisture, especially air humidity. Moisture curing is generally conducted at a temperature of not more than 40° C., where moisture curing is usually conducted at room temperature, i.e., for example, at temperatures below 35° C., for example about 23° C.

The polyurethane composition of the invention comprises a prepolymer with isocyanate end groups, formed from at least one polyisocyanate and at least one polyol. It is also possible to use mixtures of two or more prepolymers of this kind. Prepolymers with isocyanate end groups are known to the person skilled in the art. The prepolymer has at least two isocyanate end groups and preferably exactly two isocyanate end groups. By means of the isocyanate end groups, the prepolymer can be chain-extended or crosslinked by reaction with compounds having isocyanate-reactive groups, for example water, hydroxyl groups or amine groups, which brings about the curing of the polyurethane composition. The terms “curing” or “crosslinking” also include chain extension reactions hereinafter.

The prepolymer having isocyanate end groups, formed from at least one polyisocyanate and at least one polyol, is a polyurethane prepolymer which is prepared by reaction of at least one polyisocyanate and at least one polyol. The person skilled in the art is able to prepare such prepolymers directly.

The reaction of the at least one polyol with at least one polyisocyanate can be effected, for example, by reacting the polyol component and the polyisocyanate component by customary methods, for example at temperatures of 50 to 100° C., optionally in the presence of a suitable catalyst, wherein the polyisocyanate is used in a stoichiometric excess. It is optionally possible if necessary to add additives to the reaction mixture, such as solvents and/or plasticizers. The reaction product formed is the prepolymer with isocyanate end groups. Solvents, if used, can be removed again after the reaction. Plasticizers, if used, can preferably remain in the product obtained.

The polyisocyanate for formation of the prepolymer having isocyanate end groups is preferably a polyisocyanate, especially a diisocyanate, selected from aliphatic polyisocyanates and/or aromatic polyisocyanates. It is possible to use one such polyisocyanate or two or more such polyisocyanates. Preference is given to an aliphatic polyisocyanate.

An aliphatic polyisocyanate is an aliphatic compound having at least two isocyanate groups. Preference is given to an aliphatic diisocyanate. The aliphatic polyisocyanate may be an acyclic or cyclic aliphatic polyisocyanate, preference being given to a cyclic aliphatic polyisocyanate. Preference is given to a saturated aliphatic polyisocyanate. These polyisocyanates are known and commercially available.

Examples of a suitable aliphatic polyisocyanate are hexamethylene 1,6-diisocyanate, 2,2,4- and 2,4,4-trimethylhexamethylene 1,6-diisocyanate, dodecamethylene 1,12-diisocyanate, cyclobutane 1,3-diisocyanate, cyclohexane 1,3- and 1,4-diisocyanate and mixtures of these isomers, isophorone diisocyanate (IPDI, 1-isocyanato-3,3,5-trimethyl-5-isocyanatomethylcyclohexane), hexahydrotolylene 2,4- and 2,6-diisocyanate, hexahydrophenyl 1,3- and 1,4-diisocyanate, perhydro(diphenylmethane 2,4′-and -4,4′-diisocyanate), and mixtures of the aforementioned isocyanates. Particular preference is given to isophorone diisocyanate (IPDI) and hexamethylene 1,6-diisocyanate (HDI).

Examples of a suitable aromatic polyisocyanate are diphenylmethane 4,4′-diisocyanate, optionally with fractions of diphenylmethane 2,4′- and/or 2,2′-diisocyanate (MDI), tolylene 2,4-diisocyanate or mixtures thereof with tolylene 2,6-diisocyanate (TDI), phenylene 1,4-diisocyanate (PDI), and/or naphthalene 1,5-diisocyanate (NDI).

The polyisocyanate is more preferably diphenylmethane 4,4′-diisocyanate, optionally with fractions of diphenylmethane 2,4′- and/or 2,2′-diisocyanate (MDI), tolylene 2,4-diisocyanate or mixtures thereof with tolylene 2,6-diisocyanate (TDI), isophorone diisocyanate (IPDI).

In order to form the prepolymer having isocyanate end groups, the at least one polyisocyanate is reacted with one or more polyols. It is possible to use any of the polyols that are customary for polyurethane chemistry. Suitable polyols are commercially available in a wide variety.

The polyol preferably has an average molecular weight or, if it is a nonpolymeric polyol, a molecular weight of 250 to 30000 g/mol and preferably of 400 to 20000 g/mol.

The polyol also preferably has an average OH functionality in the range from 1.6 to 3. It will be appreciated that polymeric compounds may also include substances that are formed from side reactions and have, for example, just one or no hydroxyl group.

The polyol is preferably a diol or triol having an OH number in the range from 8 to 185 mg KOH/g, especially in the range from 10 to 120 mg KOH/g.

Polyols used may, for example, be the following commercially available polyols or mixtures thereof:

a) polyoxyalkylene polyols, also called polyether polyols or oligoetherols, that are polymerization products of ethylene oxide, 1,2-propylene oxide, 1,2- or 2,3-butylene oxide, oxetane, tetrahydrofuran or mixtures thereof, possibly polymerized with the aid of a starter molecule having two or more active hydrogen atoms, such as water, ammonia or compounds having two or more OH or NH groups, for example ethane-1,2-diol, propane-1,2- and -1,3-diol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, cyclohexane-1,3- and -1,4-dimethanol, bisphenol A, hydrogenated bisphenol A, 1,1,1-trimethylolethane, 1,1,1-trimethylolpropane, glycerol, aniline, and mixtures of the aforementioned compounds. It is possible to use either polyoxyalkylene polyols having a low degree of unsaturation (measured to ASTM D-2849-69 and reported in milliequivalents of unsaturation per gram of polyol (meq/g)), prepared, for example, with the aid of what are called double metal cyanide complex catalysts (DMC catalysts), or polyoxyalkylene polyols having a higher degree of unsaturation, for example prepared with the aid of anionic catalysts such as NaOH, KOH, CsOH or alkali metal alkoxides.

Polyoxyalkylene diols or polyoxyalkylene triols are particularly suitable, especially polyoxyethylene- and polyoxypropylene di- and triols.

Polyoxyalkylene diols and triols having a degree of unsaturation of less than 0.02 meq/g and having an average molecular weight in the range from 1000 to 30000 g/mol are especially suitable, as are polyoxypropylene diols and triols having an average molecular weight of 400 to 8000 g/mol.

Likewise particularly suitable are so-called ethylene oxide-terminated (“EO-endcapped”, ethylene oxide-endcapped) polyoxypropylene polyols. The latter are special polyoxypropylene polyoxyethylene polyols that are obtained for example when pure polyoxypropylene polyols, especially polyoxypropylene diols and triols, are at the end of the polypropoxylation reaction further alkoxylated with ethylene oxide and thus have primary hydroxyl groups.

b) Styrene-acrylonitrile- or acrylonitrile-methyl methacrylate-grafted polyether polyols.

c) Polyester polyols, also called oligoesterols, prepared by known methods, especially the polycondensation of hydroxycarboxylic acids or the polycondensation of aliphatic and/or aromatic polycarboxylic acids with di- or polyhydric alcohols.

Especially suitable polyester polyols are those that are prepared from di- to trihydric, especially dihydric, alcohols, for example ethylene glycol, diethylene glycol, propylene glycol, dipropylene glycol, neopentyl glycol, butane-1,4-diol, pentane-1,5-diol, 3-methylhexane-1,5-diol, hexane-1,6-diol, octane-1,8-diol, decane-1,10-diol, dodecane-1,12-diol, 1,12-hydroxystearyl alcohol, 1,4-cyclohexanedimethanol, dimer fatty acid diol (dimer diol), neopentyl glycol hydroxypivalate, glycerol, 1,1,1-trimethylolpropane or mixtures of the aforementioned alcohols, with organic di- or tricarboxylic acids, especially dicarboxylic acids, or anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, and also polyester polyols formed from lactones, for example from ε-caprolactone and starters such as the aforementioned di- or trihydric alcohols.

d) Polycarbonate polyols as obtainable, for example, by reaction of the abovementioned alcohols — used to form the polyester polyols — with dialkyl carbonates, diaryl carbonates or phosgene.

e) Block copolymers bearing at least two hydroxyl groups and having at least two different blocks having polyether, polyester and/or polycarbonate structure of the type described above, especially polyether polyester polyols.

f) Polyacrylate polyols and polymethacrylate polyols.

g) Polyhydroxy-functional fats and oils, for example natural fats and oils, especially castor oil; or polyols obtained by chemical modification of natural fats and oils — so-called oleochemical polyols — for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes such as alcoholysis or ozonolysis and subsequent chemical linkage, for example by transesterification or dimerization, of the degradation products or derivatives thereof thus obtained. Suitable breakdown products of natural fats and oils are in particular fatty acids and fatty alcohols and also fatty acid esters, in particular the methyl esters (FAME), which can be derivatized to hydroxy fatty acid esters, for example by hydroformylation and hydrogenation.

h) Polyhydrocarbon polyols, also called oligohydrocarbonols, for example polyhydroxy-functional polyolefins, polyisobutylenes, polyisoprenes; polyhydroxy-functional ethylene/propylene, ethylene/butylene or ethylene/propylene/diene copolymers; polyhydroxy-functional polymers of dienes, especially of 1,3-butadiene, which can especially also be prepared from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example polyhydroxy-functional acrylonitrile/butadiene copolymers, as can be prepared, for example, from epoxides or aminoalcohols and carboxyl-terminated acrylonitrile/butadiene copolymers; and hydrogenated polyhydroxy-functional polymers or copolymers of dienes.

The NCO/OH ratio in the reaction between polyisocyanate and the polyol is preferably in the range from 3/1 to 10/1, more preferably in the range from 3/1 to 8/1, especially in the range from 4/1 to 7/1.

The prepolymer preferably has an NCO content in the range from 0.5% to 10% by weight, preferably 0.6% to 8.4% by weight, especially 0.8% to 7% by weight.

In particular, the prepolymer having isocyanate end groups, formed from at least one polyisocyanate and at least one polyol, has a content of monomeric polyisocyanates, especially monomeric diisocyanates, of not more than 0.5% by weight, preferably not more than 0.3% by weight, in particular not more than 0.2% by weight, especially not more than 0.1% by weight.

Such a prepolymer is particularly suitable for the production of formulations such as, in particular, elastic adhesives, sealants and coatings that have a content of monomeric polyisocyanates, especially monomeric diisocyanates, of less than 0.1% by weight; these can be safely handled even without special safety precautions and can thus be sold in many countries without hazard labeling.

It has additionally been found that prepolymers having a low proportion of monomeric polyisocyanates, when used together with the nitrogen compounds used in accordance with the invention, result in particularly advantageous polyurethane compositions, in the case of which the advantages of the invention are manifested to a particular degree.

The reaction between the polyisocyanate and the polyol is preferably conducted with exclusion of moisture at a temperature in the range from 20 to 160° C., especially 40 to 140° C., optionally in the presence of suitable catalysts.

After the reaction, the monomeric polyisocyanate remaining in the reaction mixture, especially the remaining monomeric diisocyanate, can be removed by means of a suitable separation method down to the residual content described.

A preferred separation method is a distillative method, especially thin-film distillation or short-path distillation, preferably with application of reduced pressure.

Particular preference is given to a multistage method in which the monomeric polyisocyanate or diisocyanate is removed in a short-path evaporator with a jacket temperature in the range from 120 to 200° C. and a pressure of 0.001 to 0.5 mbar.

In the case of IPDI, which is the preferred monomeric diisocyanate, the jacket temperature is preferably in the range from 140 to 180° C.

Preference is given to reacting the monomeric polyisocyanate, especially the monomeric diisocyanate, and the polyol and subsequently removing the monomeric polyisocyanate remaining in the reaction mixture without use of solvents and/or entraining agents.

Preferably, the monomeric polyisocyanate removed after the reaction is subsequently reused, i.e. used again for the preparation of polymer containing isocyanate groups.

In the reaction, the OH groups of the polyol react with the isocyanate groups of the monomeric polyisocyanate, especially the monomeric diisocyanate. This results also in what are called chain extension reactions, in that there is reaction of OH groups and/or isocyanate groups of products of the reaction between polyol and monomeric polyisocyanate. The higher the NCO/OH ratio chosen, the lower the level of chain extension reactions that takes place, and the lower the polydispersity and hence the viscosity of the polymer obtained. A measure of the chain extension reaction is the average molecular weight of the polymer, or the breadth and distribution of the peaks in the GPC analysis. A further measure is the effective NCO content of the polymer freed of monomers relative to the theoretical NCO content calculated from the reaction of every OH group with a monomeric polyisocyanate.

The polymer containing isocyanate groups and having a low monomeric polyisocyanate content preferably has a viscosity at 20° C. of not more than 50 Pas, especially not more than 40 Pa·s, more preferably not more than 30 Pas. The viscosity is determined here with a cone-plate viscometer having a cone diameter 25 mm, cone angle 1°, cone tip-plate distance 0.05 mm, at a shear rate of 10 s⁻¹.

The preferred polymers or prepolymers containing isocyanate groups can be used to obtain high-quality, readily processible heat-curing and polyurethane compositions.

A particularly preferred prepolymer having a low monomeric polyisocyanate content has an NCO content in the range from 1% to 2.5% by weight, preferably 1.1% to 2.1% by weight, based on all repeat units in the polyether segment, 80% to 100% by weight, especially 80% to 90% by weight, of 1,2-propyleneoxy groups and 0% to 20% by weight, especially 10% to 20% by weight, of 1,2-ethyleneoxy groups and a monomeric polyisocyanate content of not more than 0.3% by weight, and is obtained from the reaction of IPDI with a polyether triol having an average OH functionality in the range from 2.2 to 3, preferably 2.2 to 2.8, especially 2.2 to 2.6, and an OH number in the range from 10 to 42 mg KOH/g, especially 20 to 35 mg KOH/g.

A further particularly preferred prepolymer having a low monomeric polyisocyanate content has an NCO content in the range from 2.8% to 7% by weight, based on all repeat units in the polyether segment, 100% propyleneoxy groups and a monomeric polyisocyanate content of not more than 0.3% by weight, and is obtained from the reaction of IPDI with at least one polyether diol having an OH number in the range from 44 to 120 mg KOH/g.

The proportion of prepolymer having isocyanate end groups formed from at least one polyisocyanate and at least one polyol in the polyurethane composition may, for example, be in the range from 10% to 90% by weight, especially of 15-70% by weight, preferably 20-50% by weight, in particular 25-45% by weight.

The nitrogen compound used as curing agent is selected from a polyamine, a hydrazide or mixtures thereof.

Hydrazides are a class of compounds having a functional group in which two nitrogen atoms are joined via a covalent bond. In particular, the hydrazides in the present context are organic hydrazides. These are typically derivatives of organic acids, for example carboxylic acids and/or sulfonic acids. Carbonyl hydrazides bear, as substituent, aside from at least one hydrazide group, at least one acyl group, whereas sulfonyl hydrazides bear, as substituent, aside from at least one hydrazide group, at least one sulfonyl group.

A polyamine in the present context is understood to mean an organic compound having at least two or more amino groups. In particular, the at least two amino groups are in a terminal arrangement.

The nitrogen compound used is especially in particulate form, preferably pulverulent form. In an advantageous embodiment, the nitrogen compound is in powder form with a D90 value of particle size of 50 µm, especially 20 µm, more preferably 10 µm. The particle size is determined, for example, as described in ISO 13320:2020.

In the use of the invention, the nitrogen compound is mixed with the prepolymer, preferably in such a way that the nitrogen compound is distributed uniformly in the prepolymer. In particular, the prepolymer, prior to the curing, forms a continuous phase with the particulate nitrogen compound dispersed therein.

The nitrogen compound is preferably in direct contact with the prepolymer in the polyurethane composition. Accordingly, the nitrogen compound is in free and/or unencapsulated form. Direct contact between nitrogen compound and prepolymer has the advantage that thermal curing can be activated directly with the liquefaction of the nitrogen compound, which enables controlled and rapid curing. In addition, the nitrogen compound is also freely available in the event of any moisture curing and can, depending on the reaction mechanism, take part in the curing process. Without being bound to the theory, it is suspected that the water that penetrates into the polyurethane composition in the course of moisture curing at least partly dissolves the solid nitrogen compound, such that it can take part in the moisture curing process. This might be a reason why the polyurethane compositions of the invention can be formulated with dual-cure properties.

It is further preferable when the polyurethane composition is free of aldehyde-and/or ketone-blocked amines. In particular, the polyurethane composition is free of aldimines, ketimines, enamines and/or oxazolidines. In particular, it is thus possible to reduce the risk of unwanted outgassing of aldehydes and/or ketones.

More preferably, the nitrogen compound has a melting point of at least 75° C., preferably at least 100° C., especially at least 110° C., more preferably at least 150° C. It is thus possible to achieve particularly high storage stabilities and, at the same time, segregation in the case of only partly converted curing agent is effectively reduced.

In a particularly preferred embodiment, the nitrogen compound comprises a hydrazide, in particular a dihydrazide, or consists thereof.

The hydrazide is preferably a hydrazide of a carboxylic acid and/or a sulfonic acid. In particular, it is a hydrazide of the formula (Ia) or (Ib) or (Ic):

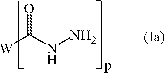

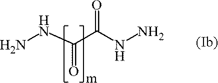

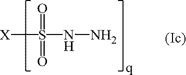

where:
W is the p-valent radical of a carboxylic acid after removal of p carboxylic acid groups;
X is the q-valent radical of a sulfonic acid after removal of q sulfonic acid groups;
m is 0 or 1;
p is 1, 2, 3 or 4, preferably 2; and
q is 1, 2, 3 or 4.

In particular, the hydrazide is a carbonyl hydrazide, especially a carbonyl dihydrazide, preferably selected from the group consisting of carbodihydrazide, oxalic dihydrazide, succinic dihydrazide, adipic dihydrazide, suberic dihydrazide, azelaic dihydrazide, sebacic dihydrazide, dodecaneoic dihydrazide and isophthalic dihydrazide, most preferably adipic dihydrazide.

With such hydrazides, which are commercially available from various suppliers, it is possible to produce, inter alia, polyurethane compositions with marked dual-cure properties.

If the nitrogen compound used is a hydrazide, prepolymers used are preferably those that are formed with isophorone diisocyanate (IPDI) and/or diphenylmethane 2,2′-diisocyanate (MDI); where the prepolymer includes a content of monomeric polyisocyanates, especially monomeric diisocyanates, of not more than 0.5% by weight, preferably not more than 0.3% by weight, in particular not more than 0.2% by weight, especially not more than 0.1% by weight.

In a further advantageous embodiment, the nitrogen compound comprises or consists of a polyamine.

The polyamine preferably has secondary and/or tertiary amino groups. In particular, the polyamine is free of primary amino groups.

More preferably, the polyamine has terminal tertiary amino groups and secondary amino groups.

An amine value of the polyamine is advantageously 150-220 mg KOH/g, especially 170-190 mg KOH/g.

In particular, the polyamine is an epoxy-amine adduct, where the epoxy-amine adduct is especially obtainable by reacting a bisphenol diglycidyl ether with an aliphatic polyamine. The aliphatic polyamine is especially a diamine, more preferably a diamine having one primary amine group and one secondary amine group and/or a diamine having one primary amine group and one tertiary amine group.

In particular, it is an adduct as described in EP 0 365 984 A2, at page 5 lines 8-16.

Such polyamines are additionally commercially available, for example under the Ancamine 2014 AS or Ancamine 2014 FG name (Evonik, Germany).

If the nitrogen compound used is a polyamine, the prepolymers used are preferably those which
(i) are formed with isophorone diisocyanate (IPDI) and/or tolylene 2,4-diisocyanate or mixtures thereof with tolylene 2,6-diisocyanate (TDI) or
(ii) are formed with isophorone diisocyanate (IPDI), tolylene 2,4-diisocyanate or mixtures thereof with tolylene 2,6-diisocyanate (TDI), diphenylmethane 4,4′-diisocyanate, optionally with fractions of diphenylmethane 2,4′- and/or 2,2′-diisocyanate (MDI); where the prepolymer includes a content of monomeric polyisocyanates, especially monomeric diisocyanates, of not more than 0.5% by weight, preferably not more than 0.3% by weight, in particular not more than 0.2% by weight, especially not more than 0.1% by weight.

The nitrogen compound is preferably used in a proportion of 0.1-15% by weight, preferably 0.5-10% by weight, in particular 0.7-5% by weight, based on the total weight of the heat-curable polyurethane composition.

The polyurethane composition of the invention may optionally also contain one or more further auxiliaries and additives that are customarily used in the polyurethane industry as additives.

Examples of such additives are plasticizers, for example esters of organic carboxylic acids or anhydrides thereof, phthalates, e.g. dioctyl phthalate or diisodecyl phthalate, adipates, e.g. dioctyl adipate, sebacates, organic phosphoric and sulfonic esters and polybutenes; solvents; inorganic and organic fillers, for example ground or precipitated calcium carbonates, carbon blacks, kaolins, aluminas, silicas and PVC powders; fibers, for example of polyethylene; pigments; rheology modifiers, for example thixotropic agents, thickeners such as urea compounds, polyamide waxes, bentonites or fumed silicas; adhesion promoters, especially silanes, such as epoxysilanes, vinylsilanes and isocyanatosilanes; desiccants, for example p-tosyl isocyanate and other reactive isocyanates, orthoformic esters, calcium oxide or molecular sieves; stabilizers against heat, light and UV radiation; flame-retardant substances; surface-active substances, for example wetting agents, leveling agents, deaerating agents or defoamers; and fungicides or substances that inhibit fungal growth.

The additives may, if required and depending on the end use, be added in suitable amounts in a customary manner. In general, it is preferable that the polyurethane composition contains at least one plasticizer and/or at least one filler.

The proportions of the constituents in the polyurethane composition may vary within wide ranges depending on the constituents used and the end use. The amounts stated below for appropriate and preferred embodiments relate to the total weight of the polyurethane composition.

More preferably, the heat-curable polyurethane composition includes the following components, based on the total weight of the heat-curable polyurethane composition:
a) 0.1-15% by weight, preferably 0.5-10% by weight, in particular 0.7-5% by weight, of the nitrogen compound;
b) 15-70% by weight, preferably 20-50% by weight, in particular 25-45% by weight, of the prepolymer;
c) 0-70% by weight, preferably 10-60% by weight, in particular 40-50% by weight, of inorganic and/or organic fillers, especially as described above;
d) 0-30% by weight, preferably 5-25% by weight, in particular 15-25% by weight, of plasticizers, especially as described above;
e) 0-5% by weight, preferably 0.5-4% by weight, in particular 1-3% by weight, of stabilizers, especially as described above;
f) 0-1% by weight, preferably 0.01-0.8% by weight, in particular 0.05-0.6% by weight, of catalysts;
g) optionally one or more additional additives, the proportions of which add up to 100% by weight.

The prepolymer and the nitrogen compound and any further components used of the composition may be mixed with one another in any sequence in order to obtain the polyurethane composition. Some components, for example the nitrogen compound, may also be added, for example, as a mixture with a plasticizer. The mixing can be effected at room temperature (e.g. 23° C.). It may also be conducted, for example, partly or entirely at slightly elevated temperature for easier homogenization or dispersion. Mixing devices used may be any of the mixing devices known in this field. The viscosity may be adjusted as desired taking account of the intended use; for example, the polyurethane composition may be pasty and may preferably have structurally viscous properties.

The heat-curable polyurethane composition may be a multicomponent, e.g. two-component, heat-curable polyurethane composition. But it is preferably a one-component heat-curable polyurethane composition.

In a preferred embodiment, the heat-curable polyurethane composition is a heat-curable and moisture-curable polyurethane composition. Specifically, in this case, it is a dual-cure polyurethane composition.

The invention also relates to a method of curing a polyurethane composition as described above, wherein the polyurethane composition is cured by the action of heat, optionally also of moisture.

The temperature used for thermal curing may vary depending on the polyurethane composition used, the desired degree of crosslinking and the duration of thermal curing. The thermal curing can be conducted, for example, at temperatures in the range from 80 to 160° C. The duration of thermal curing may, for example, be in the range from 1 to 120 min.

In a preferred embodiment, the curing is conducted partly with heating by thermal curing and partly with moisture by moisture curing, in which case particular preference is given to preliminary curing with heating, followed by further curing with moisture.

Other sequences are likewise possible in the case of performance of a combination of thermal curing and moisture curing, for example first moisture curing and then thermal curing until curing is complete, or first moisture curing, then thermal curing, and finally moisture curing again until curing is complete.

The invention also relates to a method of bonding adherends, especially vehicle parts, with the heat-curable polyurethane composition of the invention as described above, comprising:
a) the applying of the heat-curable polyurethane composition to the surfaces of one or both adherends to be bonded,
b) contacting of the adherend surfaces to be bonded and
c) curing of the polyurethane composition by thermal curing, especially at temperatures as described above, and/or moisture curing, preferably thermal curing.

The invention further relates to a method of sealing an element to be sealed with the heat-curable polyurethane composition of the invention as described above, comprising:
a) the applying of the heat-curable polyurethane composition to and/or into the element to be sealed;
b) curing of the polyurethane composition by thermal curing, especially at temperatures as described above, and/or moisture curing, preferably thermal curing.

The element to be sealed is especially a substrate, a surface, a join and/or a cavity, especially in a vehicle. In step a), the heat-curable polyurethane composition may be applied correspondingly to the substrate or the surface and/or introduced into the join and/or into the cavity.

The adherends, or the adherend surfaces to be bonded and/or the element to be sealed, may be made of any desired material, where the adherend surfaces to be bonded may be of the same material or different materials. Examples of suitable materials are metal including metal alloys, glass, plastic, ceramic, textiles or painted elements or adherends.

The heat-curable polyurethane composition can be applied to one or both adherend surfaces to be bonded or to the element to be bonded in a customary manner known to the person skilled in the art. Adherend surfaces to be bonded are contacted, optionally with pressing of the adherend surfaces to be joined onto one another.

The curing of the polyurethane composition with heat is then conducted by thermal curing. If the composition is a dual-cure polyurethane composition, the curing can also be cured solely by moisture curing or a combination of thermal curing and moisture curing.

The invention also relates to an article comprising adherends and a cured polyurethane composition as a bonded connection of the adherends, obtainable by the method of the invention. The adherends are, in particular, constituents of a vehicle.

The invention likewise relates to an element, especially of a vehicle, comprising a cured polyurethane composition as described above as sealant.

The invention accordingly also relates to a heat-curable polyurethane composition, especially a moisture-curable and heat-curable polyurethane composition, comprising:
a) a prepolymer having isocyanate end groups, formed from at least one polyisocyanate and at least one polyol, and
b) a nitrogen compound having a melting point of at least 65° C., where the solid nitrogen compound is selected from a polyamine, a hydrazide or mixtures thereof.

All the above details and elucidations relating to the heat-curable polyurethane composition, for example with regard to suitable components etc., are correspondingly applicable.

The polyurethane composition, preferably the one-component polyurethane composition, is quite generally suitable for bonding of one or more materials of the same or different characteristics and especially for bonding in vehicle construction or vehicle repair. The polyurethane composition is likewise suitable as sealant for sealing of an element, especially for sealing in vehicle construction or vehicle repair. The element is, for example, a substrate, a surface, a join and/or a cavity.

The invention is further elucidated hereinafter by examples, but these are not intended to restrict the invention in any way.

### EXAMPLES

Working examples are adduced hereinafter, which are intended to further elucidate the invention described. The invention is of course not limited to these described working examples.

Unless stated otherwise, the chemicals used were sourced from Sigma-Aldrich (Switzerland).

### Preparation of Prepolymers

### Polymer P1:

780.0 g of Desmophen^{®} 5031 BT (glycerol-started ethylene oxide-terminated polyoxypropylene triol, OH number 28.0 mg KOH/g, OH functionality about 2.3; from Covestro) and 220 g of 1-isocyanato-3,3,5-trimethyl-5-isocyanatomethylcyclohexane (Vestanat^{®} IPDI, from Evonik) were converted in the presence of 0.01 g of dibutyltin dilaurate by a known method at 80° C. to a polyetherurethane polymer having an NCO content of 6.4% by weight, a viscosity of 4.1 Pa·s at 20° C. and a monomeric IPDI content of about 12% by weight.

Subsequently, the volatile constituents, especially the majority of the monomeric IPDI, were removed by distillation in a short-path evaporator (jacket temperature 160° C., pressure 0.1 to 0.005 mbar). The polyetherurethane polymer thus obtained had an NCO content of 1.9% by weight, a viscosity of 8.2 Pa·s at 20° C. and a monomeric IPDI content of 0.02% by weight.

### Polymer P2:

725 g of Desmophen^{®} 5031 BT (glycerol-started ethylene oxide-terminated polyoxypropylene triol, OH number 28.0 mg KOH/g, OH functionality about 2.3; from Covestro) and 275 g of diphenylmethane 4,4′-diisocyanate (Desmodur^{®} 44 MC L, from Covestro) were converted by a known method at 80° C. to a polyetherurethane polymer having an NCO content of 7.6% by weight, a viscosity of 6.5 Pa·s at 20° C. and a monomeric diphenylmethane 4,4′-diisocyanate content of about 20% by weight.

Subsequently, the volatile constituents, especially the majority of the monomeric diphenylmethane 4,4′-diisocyanate, were removed by distillation in a short-path evaporator (jacket temperature 180° C., pressure 0.1 to 0.005 mbar, condensation temperature 47° C.). The polyetherurethane polymer thus obtained had an NCO content of 1.7% by weight, a viscosity of 19 Pa·s at 20° C. and a monomeric diphenylmethane 4,4′-diisocyanate content of 0.04% by weight.

Polymers P1 and P2 are prepolymers (polymers containing isocyanate groups) having a low monomeric diisocyanate content.

Viscosity was measured using a thermostated Rheotec RC30 cone-plate viscometer (cone diameter 25 mm, cone angle 1°, cone tip-plate distance 0.05 mm, shear rate 10 s⁻¹).

Monomeric diisocyanate content was determined by means of HPLC (detection via photodiode array; 0.04 M sodium acetate / acetonitrile as mobile phase) after prior derivation by means of N-propyl-4-nitrobenzylamine.

### Production of a Thickener Paste (Thixotropy Aid)

The thickener paste was produced by gently heating an initial charge of 300 g of diisodecyl phthalate and 48 g of diphenylmethane 4,4′-diisocyanate (Desmodur^{®} 44 MC L, from Covestro) in a vacuum mixer and then slowly adding 27 g of monobutylamine dropwise while stirring vigorously. The resultant paste was stirred for a further hour under reduced pressure while cooling.

### Polyurethane Compositions

The ingredients specified in table 1 in the amounts specified (in parts by weight) were mixed well by means of a planetary mixer under reduced pressure and the exclusion of moisture to give one-component polyurethane compositions C1 and C2, and stored with exclusion of moisture until use.

TABLE 1

Polyurethane compositions.

| Composition → | C1 | C2 |
|---|---|---|
| ↓ Ingredients | | |
| Polymer P1 | - | 35.0 |
| Polymer P2 | 30.0 | - |
| Curing agent | | |
| - Polyamine¹ | 2.7 | - |
| - Hydrazide² | - | 1.2 |
| Chalk³ | 30.0 | 36.8 |
| Carbon black⁴ | 16.0 | - |
| Plasticizer⁵ | 21.3 | - |
| Thixotropy aid⁶ | - | 25.0 |
| Rheology aid⁷ | - | 2.0 |
| | 100.0 | 100.0 |

¹ Ancamine 2014 FG (Evonik)
² adipic dihydrazide
³ Omyacarb^{®} 5 GU (from Omya)
⁴ Monarch®570 (Cabot Corp.)
⁵ diisodecyl phthalate
⁶ thickener paste (produced as described above)
⁷ Cab-O-Sil TS-720 (hydrophobic silica; Cabot Corp.)

Composition C1 was storable without any problem at temperatures up to 40° C. over several months and was curable in a controlled manner at a temperature of 100° C. In addition, it was found that composition C1 can also be cured by moisture curing at RT, leaving the unconverted polyamine in the cured product or with no oily liquid or the like exuding from the cured product even on subsequent heating.

Composition C2 was storable without any problem at room temperature (RT) over several months and was curable in a controlled manner at a temperature of 120° C. Like composition C1, composition C2 can also be cured by moisture curing at RT without exudation of oily liquid or the like from the cured product on subsequent heating.

The dual-cure properties are more marked in the case of composition C2 than in the case of composition C1. Specifically, the moisture-cured composition C1 has slightly different mechanical properties (tensile strength, elongation at break and modulus of elasticity) than the heat-cured composition C1. In the case of composition C2, by contrast, irrespective of the mode of curing (moisture/heat), essentially identical mechanical properties were obtained, which suggests a complete dual-cure system.

However, the working examples above should be regarded merely as illustrative examples which can be modified as desired within the scope of the invention.

1. (canceled)

2. The heat-curable one-component polyurethane composition as claimed in claim 14, wherein the nitrogen compound has a melting point of at least 75° C.

3. The heat-curable one-component polyurethane composition as claimed in claim 17, wherein the hydrazide is a carbonyl hydrazide.

4. The heat-curable one-component polyurethane composition as claimed in claim 16, wherein the polyamine has terminal tertiary amino groups and has secondary amino groups.

5. The heat-curable one-component polyurethane composition as claimed in claim 16, wherein the polyamine is an epoxy-amine adduct.

6. The heat-curable one-component polyurethane composition as claimed in claim 14, wherein the nitrogen compound comprises a powder having a D90 of particle size, determined by ISO 13320:2020, of 50 µm.

7. The heat-curable one-component polyurethane composition as claimed in claim 14, wherein the nitrogen compound in the polyurethane composition is in direct contact with the prepolymer.

8. The heat-curable one-component polyurethane composition as claimed in claim 14, wherein the nitrogen compound is used in a proportion of 0.1-15% by weight based on a total weight of the heat-curable one-component polyurethane composition.

9. The heat-curable one-component polyurethane composition as claimed in claim 14, wherein the polyisocyanate is diphenylmethane 4,4′-diisocyanate.

10. The heat-curable one-component polyurethane composition as claimed in claim 14, wherein a NCO/OH ratio in the reaction between the polyisocyanate and the polyol is in a range from 3/1 to 10/1.

11. The heat-curable one-component polyurethane composition as claimed in claim 14, wherein the prepolymer having isocyanate end groups, is formed from the at least one polyisocyanate and the at least one polyol, via a content of monomeric polyisocyanates of not more than 0.5% by weight.

12. The heat-curable one-component polyurethane composition as claimed in claim 14, wherein the heat-curable polyurethane composition comprises the following components based on a total weight of the heat-curable one-component polyurethane composition:
a) 0.1-15% by weight of the nitrogen compound;
b) 15-70% by weight of the prepolymer;
c) 0-70% by weight of inorganic and/or organic fillers;
d) 0-30% by weight of plasticizers;
e) 0-5% by weight of stabilizers;
f) 0-1% by weight of catalysts;
g) optionally one or more additional additives.

13. The heat-curable one-component polyurethane composition as claimed in claim 14, wherein the polyurethane composition is a one-component adhesive and/or sealant.

14. A heat-curable one-component polyurethane composition comprising:
a) a prepolymer having isocyanate end groups, formed from at least one polyisocyanate and at least one polyol, and
b) a nitrogen compound having a melting point of at least 65° C., where the solid nitrogen compound is selected from a polyamine, a hydrazide, or mixtures thereof,
wherein the nitrogen compound acts as a curing agent for thermal curing of the heat-curable one-component polyurethane composition.

15. A method of curing a polyurethane composition as claimed in claim 14, wherein the polyurethane composition is cured by the action of heat and/or moisture.

16. The heat-curable one-component polyurethane composition as described in claim 14, wherein the nitrogen compound comprises a polyamine.

17. The heat-curable one-component polyurethane composition as described in claim 14, wherein the nitrogen compound comprises a hydrazide.

18. The heat-curable one-component polyurethane composition as described in claim 14, wherein the nitrogen compound comprises a mixture of a polyamine and a hydrazide.
